(19) United States
(12) Patent Application Publication
(10) Pub. No.: US 2004/0080832 A1
(43) Pub. Date: Apr. 29, 2004

(54) Solid state etalons with low thermally-induced optical path length change employing crystalline materials having significantly negative temperature coefficients of optical path length

(76) Inventor: Mandeep Singh, Lorentzweg (NL)

Correspondence Address: Samuels, Gauthier & Stevens LLP, Suite 3300, 225 Franklin Street, Boston, MA, 02110, US

(21) Appl. No.: 10/606,685

(22) Filed: Jun. 26, 2003

Related U.S. Application Data
(63) Continuation-in-part of application No. 10/218,753, filed on Aug. 14, 2002.
(60) Provisional application No. 60/392,342, filed on Jun. 28, 2002.
(60) Provisional application No. 60/399,887, filed on Jul. 31, 2002.

(51) Int. Cl. G02B 27/00

(52) U.S. Cl. 359/578

(57) ABSTRACT

An etalon is disclosed comprising a first rutile or strontium titanate material having a first coefficient of thermal optical path length change β₁ that has a negative value, coupled with a second material having a coefficient of thermal optical path length change β₂ that is positive, and an optical path extending through the first material and the second material, such that the effective temperature coefficient of the optical path length is close to zero. Further, the total optical path length in the cavity gives a desired free spectral range of the etalon. Etalons composed of a single crystalline material are also disclosed. Such materials may include crystalline quartz.

### PRIORITY INFORMATION

This application is a continuation-in-part application of U.S. Ser. No. 10/218,753 filed Aug. 14, 2002 and claims priority from U.S. provisional application Ser. No. 60/392,342 filed Jun. 28, 2002 as well as U.S. provisional application Ser. No. 60/399,887 filed Jul. 31, 2002.

### BACKGROUND

The invention relates to passive optical devices and particularly to etalons used to filter, select or transmit a narrow bandwidth of optical frequency from an optical beam or signal having a broader optical frequency bandwidth. In particular, the invention relates to etalons used in optical telecommunication systems where there is a demand for selecting or transmitting very narrow discrete optical frequency bandwidths of predetermined optical frequency from a broadband optical signal. Such predetermined discrete optical frequencies or channels may comprise standardized communication channels, usually in the near-infrared spectral region (800 nm to 2000 nm), most particularly the portions of the spectrum commonly designated as C and L bands, covering the wavelength range 1520 nm to 1620 nm approximately, most suited for dense wavelength division multiplexing (DWDM) of the communications channels. Recently there has been a need to distinguish even narrower channel bandwidths thereby enabling the use of more channels having more closely spaced discrete mean frequencies. Accordingly, it is a critical aspect of optical telecommunications passive elements that they may continuously operate to select, transmit or receive optical signals having very narrow discrete optical frequencies.

In optical telecommunication systems, there have been a number of recent developments in the use and fabrication of etalons to control the optical frequency transmission range of the etalon cavity. In solid-state etalons, great care is taken to use homogeneous optical materials to provide a solid etalon cavity with a uniform refractive index throughout. In addition, recent developments have lead to the ability to more precisely measure and fabricate solid etalon cavity material thickness to generate etalon cavities with narrow band pass characteristics while at the same time being centered upon a predetermined discrete optical frequency range. In air-space or gas-space or vacuum chamber etalons, these same measurement and fabrication techniques have been used to fabricate the gas filled or evacuated etalon cavity thickness by controlling the dimension of a unitary spacer material or discrete spacer elements that define the etalon cavity thickness. Such techniques may control the cavity thickness to provide etalon cavities with thickness variations within a range of about 20-200 nanometers.

FIG. 1A depicts a conventional solid etalon 10A and FIG. 1B depicts a conventional gas filled or evacuated etalon 10B. Each etalon 10A, 10B includes an upper material 20A, 20B and a lower material 25A, 25B, each of which is formed of a glass or crystal substrate polished with end faces parallel to within a few seconds of arc, with dielectric two partial or one partial and one high reflectance coatings on either side. Each element includes a cavity 30A, 30B having a cavity length 35A, 35B. In the air-space etalon 10B, careful fabrication of the spacers 40B, which may comprise separate elements or an annular element, is used to control the cavity length 35B, while in the solid etalon 10A, careful control of the thickness of the solid etalon material is used to control the cavity length 35A. In general, each etalon cavity 30A, 30B includes an input surface 45A, 45B and an output surface 50A, 50B that are optically coated to enhance the performance of the cavity. A laser (usually wavelength-tunable) or broad-band optical beam 55A, 55B or optical signal, having an optical frequency or an optical wavelength (λ) and an optical frequency or optical wavelength bandwidth (Δλ) enters the etalon 10A, 10B from an input side at substantially normal incidence with respect to the cavity 30A, 30B and first passes through the input window 20A, 20B, into the etalon cavity 30A, 30B and exits through the output window 25A, 25B.

In operation, the etalon cavity length 35A, 35B and refractive index (n) of the cavity material are selected to provide destructive phase interference between the entering beam or signal 55A, 55B and a reflected beam or signal 60A, 60B that is reflected from the output face 50A, 50B. Such a destructive interference occurs when the cavity length 35A, 35B is (N+½)λ, where N is an integer. The cavity 30A, 30B will have a maximum optical signal transmission when the cavity length 35A, 35B is an integer multiple of one half the wavelength (Nλ/2)—in this case the cavity is said to be in resonance.

The optical path length (OPL), or optical phase thickness (φ) in radians of an etalon cavity is given by:

$$φ = \frac{2 π}{λ} nd cos θ \qquad ( 1 )$$

where n is the index of the cavity material, d is the cavity length 35A, 35B, λ is the optical wavelength of the optical signal beam and θ is the propagation angle that the input beam 55A, 55B induces within the cavity input surface 45A, 45B. By taking the case of near-normal angle of incidence of the light beam, the cos θ approximates to 1, and equation 1 becomes a function of only n, d and λ. At optical frequencies used in telecommunications e.g., 193 GHz, the wavelength of the signal beam is approximately 1553.37 nanometers, (nm). Accordingly a change in the etalon cavity length of only a few hundred nm can significantly change the performance of the etalon.

One problem with the conventional etalons described above is that there is a frequency band pass (resonance peak) drift, which is dependent on the etalon cavity temperature, and this frequency band pass drift is unacceptable and undesirable in more recent telecommunications systems. One solution to the problem is to precisely control the operating temperature of the optical system such as with a thermal controller (cooler/heater), or the like, attached to or near the etalon to precisely control the temperature of the etalon. Alternatively, a climate control system may be provided to precisely control the environment temperature of the optical system. However these solutions have proven to be expensive and impractical in certain telecommunications systems. In addition, the desired degree of precise temperature control is usually not attainable. For example in the example given above, the change in etalon cavity linear length may result from only a small temperature change when using fused silica as a solid etalon cavity material. In addition, the indices of refraction of the etalon material (solid and gas) also vary with temperature and this leads to further performance degradation with changing temperature if these two variations do not compensate each other.

A variety of techniques have been developed to provide temperature compensation in etalons. U.S. Pat. No. 6,215,802 discloses a re-entrant etalon to that is disclosed to be thermally stable by employing an etalon gap that is several times thicker than the etalon riser. U.S. Pat. No. 5,856,991 discloses the use of etalon spacers in a laser system in which temperature stability of the etalons is disclosed to be achieved by using low thermal expansion coefficient etalon spacers and good thermal management of the etalon housing. U.S. Pat. No. 6,236,667 discloses a method for temperature compensating an optical filter such as an etalon employing a feedback resistor in a transimpedance amplifier having a temperature dependence value that is selected to offset temperature related changes in transmission through the optical filter. Such systems, however, have not been found to provide satisfactory etalon temperature stability in certain applications.

U.S. Pat. No. 6,005,995 discloses Fabry-Perot etalons that are disclosed to have improved temperature stability by employing materials having a low thermal expansion coefficient and a negative dn/dt in the etalon cavity, such as FK51 glass from Schott Glass, Inc. of Duryea, Pa., as shown in FIG. 3 thereof. U.S. Pat. No. 6,055,995 also discloses a composite etalon formed of a first material with a positive temperature coefficient, and a second material with a negative temperature coefficient such as acrylic or Polycarbonate, as shown in FIG. 4 thereof. U.S. Pat. No. 6,005,995 further discloses that thermal instability may be reduced by a factor of ten, and that an iterative procedure may be employed to further reduce thermal instability. Such composite etalons formed of acrylic or Polycarbonate, however, do not provide sufficient temperature stability in certain applications.

U.S. Pat. No. 6,452,725 discloses the use of a crystalline salt in an etalon and U.S. Pat. No. 6,486,999 discloses the use of certain crystalline materials in etalons to enhance thermal stability, however these crystalline materials have also been found unsuitable for certain applications, such as telecommunications applications. For example, crystals such as LiCaAIF₆ (or LICAF as disclosed in U.S. Pat. No. 6,486,999) have a relatively low index of refraction (1.38), which requires that etalons formed of such crystals have be of a minimum size. Moreover, in a two-component etalon (or a mounted etalon), there is a risk of de-contacting or warping if there is a mismatch in the coefficient of thermal expansion (CTE) in the plane perpendicular to the direction of light propagation. The mismatch of LICAF CTE with common glasses and crystals is relatively large. Further, the CTE anisotropy of LICAF is rather high and may lead to thermal cracking.

Accordingly there is a need in the art to maintain uniform etalon cavity transmission characteristics over a range of temperatures.

### SUMMARY OF THE INVENTION

In accordance with an embodiment, the invention provides an etalon comprising crystalline optically homogeneous materials including rutile or strontium titanate that exhibit negative thermally induced optical path length characteristics unlike those of typical glasses and fused silica, which are positive in the near-infrared spectral region. The first materials preferably have a significantly negative β. The second material may be, for example, a glass e.g., BK 7 or another crystal e.g., quartz (0001) (with positive β). In a further embodiment, the resultant optical path length is determined by the desired free spectral range (FSR) of the etalon, and the partition ratio of the two materials is set such that the overall thermally-induced optical path length change is compensated to an effective value approaching zero.

### BRIEF DESCRIPTION OF THE DRAWINGS

The following detailed description may be further understood with reference to the accompanying drawings in which:

FIGS. 1A and 1B show illustrative diagrammatic views of prior art etalons;

FIG. 2 shows an illustrative diagrammatic view of an etalon in accordance with an embodiment of the invention;

FIG. 3 shows an illustrative diagrammatic view of an etalon cavity in accordance with another embodiment of the invention;

FIG. 4 shows an illustrative diagrammatic view of an etalon cavity in accordance with a further embodiment of the invention; and

FIG. 5 shows an illustrative diagrammatic view of an etalon cavity in accordance with a further embodiment of the invention.

The drawings are shown for illustrative purposes only and are not to scale.

### DETAILED DESCRIPTION OF THE ILLUSTRATED EMBODIMENTS

It is conventionally known that crystals such as LICAF may be used to form etalons and that it is desirable to provide a material with a temperature coefficient of optical path length that, though negative, is close to zero. It has been discovered, however, that etalons may be formed using certain crystals such as rutile and strontium titanate, which in fact have a relatively large negative temperature coefficient of optical path length. Such materials may be used together with other materials that have a significant positive temperature coefficient of optical path length to yield an efficient thermally insensitive etalon.

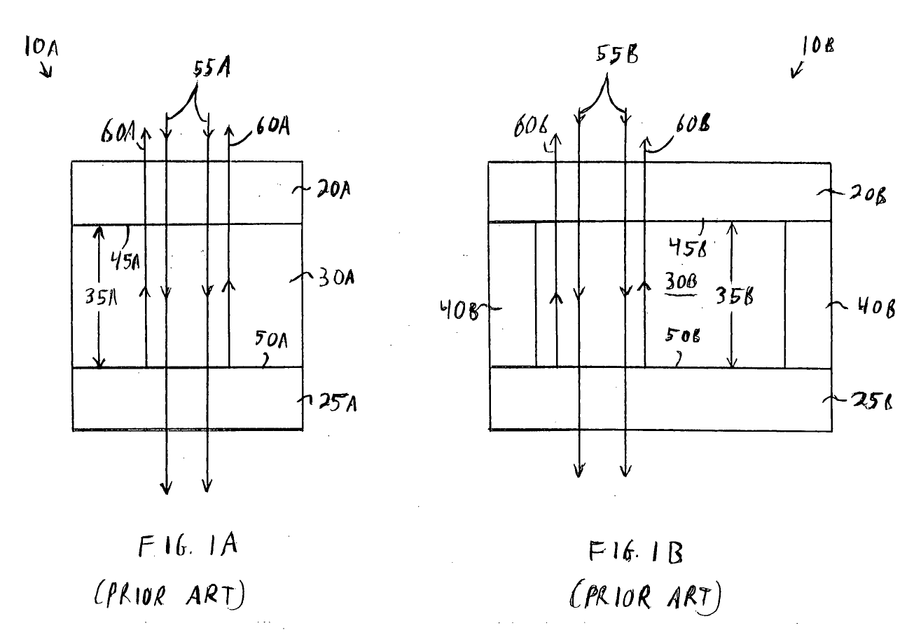

As discussed above with reference to FIGS. 1A and 1B, changes in the OPL of an etalon cavity with respect to temperature are affected by the change in refractive index of the cavity material (n) with respect to temperature (T), (dn/dT) and changes in the linear length of the cavity (d) with respect to temperature. In a solid etalon, the linear length change with respect to temperature is given by dαₑ where αₑ is the coefficient of linear thermal expansion of the etalon material. In a gas or evacuated etalon, the linear length change is given by dα_{S} where α_{S} is mainly the linear coefficient of thermal expansion of the spacer material.

The Snell condition at the interface of a first material having an index of refraction n₀ and a second material having an index of refraction n is given by sin Φ/sin θ=n/n₀ where Φ is the angle of incidence from the first material (measured from normal), and θ is the angle of refraction into the second material (measured from normal).

To determine the thermal sensitivity of an etalon cavity, the phase thickness as in equation (1) is differentiated with respect to temperature assuming cos θ≈1 (near-normal incidence operation) and a near-zero extinction coefficient. The phase thickness may be given in terms of the angle of incidence as:

$$φ = \frac{2 π}{λ} d ( {n}^{2} - {n}_{0}^{2} {sin}^{2} ϕ ) \qquad ( 2 )$$

The change in phase thickness with temperature T is then given (in radians) by:

$$Δ φ = \frac{2 π nd}{λ} [ α + \frac{1}{n} \frac{ⅆ n}{ⅆ T} ] Δ T \qquad ( 3 )$$

where α is the coefficient of linear thermal expansion of the optical cavity material. The temperature derivative of the phase thickness is therefore:

$$\frac{ⅆ φ}{ⅆ T} = \frac{2 π}{λ} \frac{d}{{( {n}^{2} - {n}_{0}^{2} {sin}^{2} ϕ )}^{1 / 2}} ( {n}^{2} β - {n}_{0}^{2} {β}^{′} {sin}^{2} ϕ ) \qquad ( 4 )$$

Accordingly, a temperature coefficient of optical path length β of a homogeneous isotropic material (or of a uniaxial anisotropic crystal with a (0001) incidence plane and propagation parallel to the optical (c-axis)) is given (in units of K⁻¹) as:

$$β = \frac{λ}{2 π nd} \frac{Δ φ}{Δ T} = [ α + \frac{1}{n} \frac{ⅆ n}{ⅆ T} ] \qquad ( 5 )$$

This is provides the temperature coefficient of the optical path length in the material, and

$${β}^{′} = \frac{1}{{n}_{0}} \frac{ⅆ {n}_{0}}{ⅆ T} + α \qquad ( 6 )$$

The values dnⱼ/dT are the thermo-optic coefficients of the material and the incident medium, and α is the coefficient of linear thermal expansion of the material. The athermal condition for the phase thickness (dφ/dT→0) implies that, in the first approximation, there is a unique angle of incidence at which change in the optical path length is zero for all T:

$$sin ϕ = \frac{n}{{n}_{0}} {( \frac{β}{{β}^{′}} )}^{1 / 2} \qquad ( 7 )$$

For an ideal athermal etalon β→0. Using conventional solid etalon materials, e.g., fused silica (Corning), β=7.09×10⁻⁶ K⁻¹. An alternative solid etalon material is the Schott glass N-LAK12 which yields: β=5.9×10⁻⁶ K⁻¹.

The following Table I shows possible materials for solid-state and air-spaced etalons using conventional etalon designs. As may be seen, conventional solid etalon materials have a significantly higher β than gas filled etalons.

TABLE I

| | Resonance | |
|---|---|---|
| | peak shift | |
| Material | (GHz/K) | β/10⁻⁶ K⁻¹ |
| Fused Silica | −1.2 | 6.8 |
| Schott N-LaK12 | −1.1 | 5.9 |
| Open Cavity air-spaced | 0.15 | −0.83 |
| (ULE spacers) | | |
| Closed Cavity air-spaced | −0.001 | 0.008 |
| (ULE spacers) | | |
| Crystalline Quartz (0001) | −0.624 | 3.4 |

According to the present invention, it is recognized that the temperature-dependent path length change for an etalon composed of j materials is simply:

$$Δφ = {\sum }_{j}^{} \frac{2 π {n}_{j} {d}_{j}}{λ} {β}_{j} Δ T \qquad ( 8 )$$

which indicates that for thermal path length compensation to be achieved in an etalon cavity, a plurality of materials such that the sign of the product of the β-values is negative (Πβⱼ) may be fabricated providing an etalon with a negligibly low OPL change over a range of temperatures.

To attain negative β, the condition (dn/dT)/n<−α must hold even though the thermal coefficient of expansion a for nearly all useful materials is greater than zero. This condition is believed to be unattainable for catalogued commercial glasses. In accordance with the invention, however, some crystals (most of which may be birefringent) e.g., uniaxial crystals like rutile (TiO₂), and an isotropic crystal like strontium titanate etc. may be used in combination with conventional optical glasses to meet the required condition.

If the angle of incidence Φ is held constant, optical devices such as etalons, light guides and virtual-image arrays may be designed to be intrinsically athermal. The condition that should be fulfilled, however, is that sin Φ<1. In addition, β/β′≧0. Otherwise, Φ would be a complex angle. In the case of a composite device, e.g., the Rutile/BK7 athermal etalon, we can assume a single effective value of parameters.

The Table II below summarizes some selected numerical data for various optical configurations. The angle Φ given in Table II is the angle at which the device operates in a self-compensating athermal mode. The data is for telecom-compatible devices operating near λ=1570 nm. The range of the propagation angles is compatible with a range of elements, e.g., etalons and virtual-image arrays. Similar device may be designed to operate in reflecting waveguide modes for which larger angles are required to launch the guided modes.

TABLE II

| Incident | Optical | | n(or | | | ρ |
|---|---|---|---|---|---|---|
| medium | Element | n₀ | effective n) | β(10^{-6/K)} | β′(10⁻⁶/K) | (Degrees) |
| Air | Fused | 1 | 1.4444 | 7.0 | 6.0 | — |
| | Silica | | | | | |
| Air | Rutile/ | 1 | 1.75 | 0.01 | 7.0 | 3.8 |
| | BK7 | | | | | |
| Air | Rutile/ | 1 | 1.75 | 0.05 | 7.0 | 8.5 |
| | BK7 | | | | | |
| Silicon | Fused | 3.4 | 1.444 | 7.0 | 60 | 8.3 |
| | Silica | | | | | |
| Silicon | Rutile/ | 3.4 | 1.75 | 0.05 | 60 | 0.85 |
| | BK7 | | | | | |

The above demonstrates that athermalization of certain optical elements may be achieved using selected materials at an angle of incidence of less than about 10 degrees. The basis for the approach is the temperature-dependent change in the Snell condition and therefore the propagation angle at the interface. The change in the propagation angle with temperature serves to compensate the thermally-induced optical path length of the device.

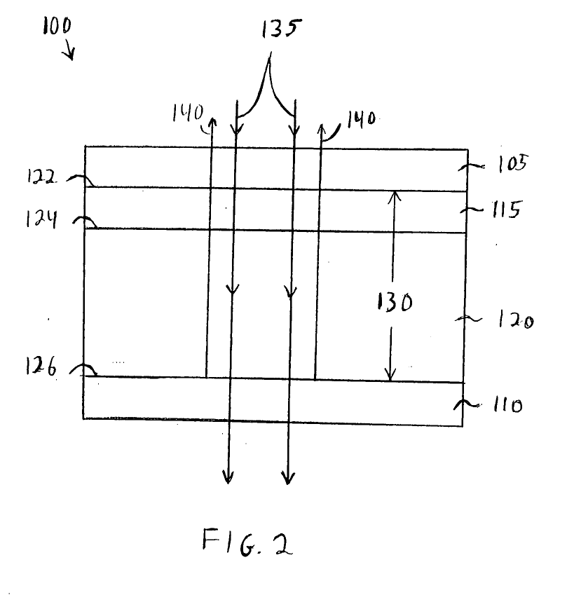

As shown in FIG. 2 an athermalized solid etalon 100 according to the present invention includes top and bottom optically transparent input and output elements 105 and 110 respectively. The solid etalon cavity comprises a first cavity element 115 having a first β value β₁ and a second cavity element 120 having a second β′ value, β₂. In this embodiment, there are three optical interfaces 122, 124, 126 within the etalon cavity that involve surfaces that may be each coated by a conventional optical coating to improve the etalon performance. Moreover, each of the elements mating at the interfaces 122, 124, 126 are preferably optically contacted together without the use of glue or other bonding or fastening materials on the mating surfaces.

The etalon 100 has a cavity length 130 that is selected to provide an appropriate optical transmission characteristic for the incoming signal beam 135 and reflection or destructive interference of the reflected beam 140. In the present embodiment the first cavity element comprises a rutile crystal cut with the a-axes lying in the incidence plane (i.e., a (001) basal plane) to eliminate birefringence and hence two transmission spectra, each associated with the two polarizations (s and p). The second element comprises a conventional optical glass, e.g., BK7. In the case of Rutile, β=−15×10⁻⁶ K⁻¹, n_{E}=2.71 at 1550 nm and in the case of BK7 β=8.9×10⁻⁶ K⁻¹, n=1.50 at 1550 nm such that that the two materials have an opposite shift in OPL with respect to temperature. To determine the thickness of each of the separate elements in a two-component system it is desirable that Δφ/ΔT→0. Thus according to equation 2, the physical thickness ratio is given by:

$$\frac{{ⅆ}_{1}}{{ⅆ}_{2}} = - \frac{{n}_{2} {β}_{2}}{{n}_{1} {β}_{1}} \qquad ( 9 )$$

From this relation, it is clear that when either d₁ or d₂ is substituted from the above relation in to the relation n₁d₁+n₂d₂=c/(2F), the etalon cavity with a Free Specral Range (FSR) of F (usually in units of GHz), the athermal condition for the etalon is fulfilled (c is the velocity of light). Compromises, however, in the choice of the two materials e.g., for de-contacting coefficient of thermal expansion (CTE) matching may be required in certain situations. Other useful materials with negative β are Strontium Titanate, PbS and KRS-5. It should be noted that the Poisson ratio and stress-optic coefficients may become significant in multi-component etalons and lower the effective value of β. The salient feature of this embodiment described is that athermal optical cavity lengths may be achieved combining any two materials with a particular thickness ratio such that in one of the materials the thermally-induced optical path length change as described by β has a negative value in the wavelength region of interest.

It has been discovered that a birefringent (uniaxial) material, e.g., crystalline quartz, may be used to operate as a polarization-independent etalon cavity if the crystal is cut such that a (0001) basal plane lies in the plane of incidence and the c-axis is along the direction of propagation in the cavity. Partially reflecting dielectric coatings may be deposited on each side of a quartz plate cut in the manner described above. The shift in the resonant peaks of the transmittance of the etalon may be monitored as a function of temperature between 0 and 70 degrees Celsius. A mean peak shift rate of −0.624 GHz/K (β=3.4×10⁻⁶ K⁻¹) in this temperature range has been observed. This value is a factor of two improvement on that of fused silica. For example, as shown in FIG. 3, an etalon cavity 150 of crystalline quartz may have a refractive index of n_{E} (in a direction parallel to the c-axis) and a depth d. The etalon cavity 150 also includes surfaces 152 and 154 that are coated with partial or high reflectors, and are polished in parallel with one another to within a few seconds of arc. The surfaces 152 and 154 are also the basal (0001) planes.

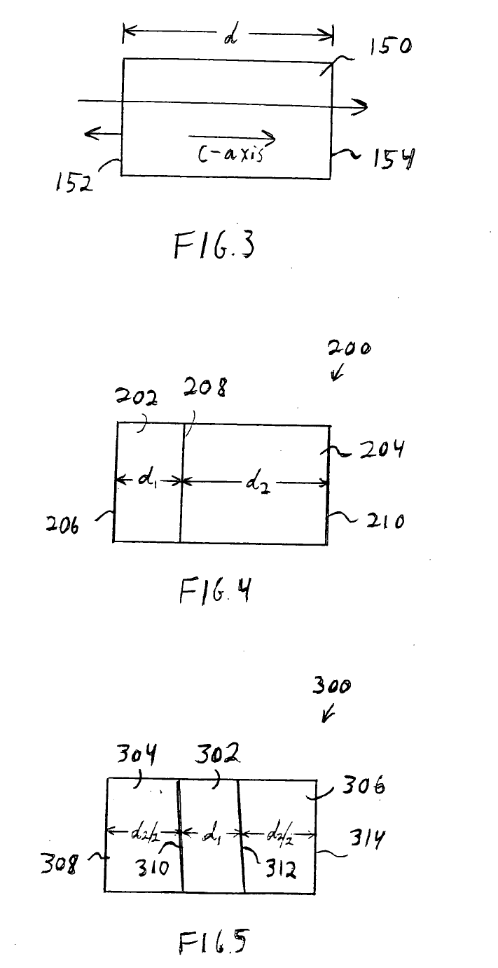

In accordance with an embodiment of the invention, an etalon may be formed, for example, with rutile (having β=−15×10⁻⁶ K⁻¹, n_{C}=2.71 at 1550 nm), and BK7 (having β=8.9×10⁻⁶ K⁻¹, n=1.50 at 1550 nm). The etalon may have a free spectral range of 50 GHz, for example. The cavity for such an etalon is shown in FIG. 4. The cavity 200 includes a rutile portion 202 having a refractive index of n_{c} and a depth of d₁, and a BK7 portion 204 having a refractive index of n and a depth of d₂. The exposed rutile surface 206 is a rutile (0001) plane and the optically contacted surface 208 between the rutile and BK7 includes an anti-reflective (AR) coating. The surface 208 may also be wedged with respect to the exposed surfaces 206 and 210 by up to about 0.5 degrees to avoid internal reflections from the surface 208.

As shown in FIG. 5, an etalon cavity 300 in accordance with a further embodiment of the invention may include BK7 material on either side of a rutile material. The cavity 300 includes a rutile portion 302 having a refractive index of n_{c} and a depth of d₁, a BK7 portion 304 having a refractive index of n and a depth of d₂/2 and another BK7 portion 306 having a refractive index of n and a depth of d₂/2. The exposed rutile surface 308 is a rutile (0001) plane and the optically contacted surfaces 310, 312 between the rutile and BK7 include AR coating. The surfaces 310, 312 may be either normal to the optical axis or may be with respect to the optical axis by up to about 0.5 degrees to avoid internal reflections from the surfaces 310, 312. The etalon (−β/+β) cavity 300 provides a constant free spectral range.

The temperature dependence of the Snell's law relationship at the interface between two isotropic optical media may be used, under certain conditions, to realize intrinsically-athermal optics that operate necessarily at non-normal angles of incidence. This approach provides that the angle of ray propagation in a medium may change with temperature due to the thermally-induced change in the refractive indices at the interface, modifying the Snell condition. This change in the propagation angle may be used to maintain a constant optical path length in the medium irrespective of temperature. Optical elements such as etalons, waveguides and virtual-image arrays (VIA) are amenable to this approach.

As shown in Table III, the use of rutile or strontium titanate actually provide an improved match with common positive beta materials.

TABLE III

| | | Strontium | |
|---|---|---|---|
| | Rutile | Titanite | LICAF |
| Crystal Type | Tetragonal, | Cubic, | Tetragonal, |
| | Uniaxial | Isotropic | Uniaxial |
| Crystal cut | Z-cut | Any | Z-cut |
| requirement | | | |
| Refractive | 2.71 | 2.28 | 1.38 |
| Index | (along c-axis) | | (along c-axis) |
| Thermal | 7.4 | 11.2 | −5 |
| conductivity | (\|\| a-axis), | | |
| (W/m · k) | 10.4 | | |
| | (along c-axis) | | |
| CTE along a- | 7 | 8 | 22 |
| axis (× 10⁻⁶ k⁻¹) | | (isotropic) | |
| CTE along c- | 9 | — | 3.5 |
| axis (× 10⁻⁶ k⁻¹) | | | |
| CTE anisotropy | Low | Zero | Extremely |
| | | | High |
| FOM (Beta) = | −22 | −13 | −0.4 |
| (1/n) · dn/dT + | | | |
| CTE (× 10⁻⁶ K⁻¹) | | | |
| CTE match to | Very good | Very good | Poor |
| common | | | |
| positive Beta | | | |
| materials | | | |

Although isotropic crystals are preferred in certain embodiments, uniaxial materials are acceptable at small angles of incidence in some embodiments. Uniaxial crystals must be z-cut such that the light propagation direction is along the optic (c) axis. In isotropic crystals this is not an issue, although certain directions may be preferred due to cleavage considerations. A high index of refraction is generally desirable to make etalons of very small dimensions. The index of refraction of LICAF is lower than that of fused silica. High thermal conductivity is preferred on account of generating low T gradients within the etalon. The CTE along the respective axes is an important parameter in the design. In a two-component etalon, there is a risk of de-contacting or warping if there is a mismatch in the CTE in the plane perpendicular to the direction of light propagation. The mismatch of LICAF CTE with common glasses and crystals is large. Even in a single component etalon, the large CTE of LICAF may become a problem in mounting and associated thermally induced strain. The extremely high CTE anisotropy of LICAF may lead to thermal cracking in certain applications.

As discussed above, it has been conventionally thought that the temperature coefficient of optical path length should be negative and as low as possible, ideally even zero. It has been discovered, however, that an etalon including a crystal having a more negative temperature coefficient of optical path length (e.g., β=about −1 to β=about −50, and preferably β=about −7 to β=about −25) provides significantly improved etalons when combined with materials having a positive temperature coefficient of optical path length that is not close to zero. Very small negative value of β may lead to a situation where a prohibitively thin positive β material is required in the compound etalon to achieve near-perfect athermalicity.

Those skilled in the art will appreciate that numerous modifications and variations may be made to the above disclosed embodiments without departing from the spirit and scope of the invention.

What is claimed is:

1. An etalon comprising:
a first rutile material having a first coefficient of thermal optical path length change β₁;
a second material having a second coefficient of thermal optical path length change β₂;
an optical path extending through said first material and said second material, wherein one of β₁ and β₂ is negative.

2. The etalon as claimed in claim 1, wherein said second material includes an optical glass.

3. The etalon as claimed in claim 1, wherein said second material includes Bk7.

4. The etalon as claimed in claim 1, wherein said second material includes a crystal.

5. The etalon as claimed in claim 1, wherein said second material includes a quartz.

6. The etalon as claimed in claim 1, wherein said etalon further includes an anti-reflective coating between said first rutile material and said second material.

7. An etalon comprising:
a first material having a first thickness d₁, a first index of refraction n₁, and a first coefficient of thermal optical path length change β₁, wherein β₁<−1.0;
a second material having a second thickness d₂, a second index of refraction n₂, and a second coefficient of thermal optical path length change β₂, wherein the ratio d₁/d₂ equals-(n₂β₂ )/(n₁β₁).

8. The etalon as claimed in claim 7, wherein −7 >β₁>−25.

9. The etalon as claimed in claim 7, wherein said etalon includes BK7.

10. The etalon as claimed in claim 7, wherein said etalon includes quartz.

11. The etalon as claimed in claim 7, wherein said etalon includes silicon.

12. An etalon including strontium titanate.

13. An etalon including a rutile material and a coefficient of optical path length that is approximately zero.

14. An etalon including a strontium titanate material having a negative β, a positive β material, and a coefficient of optical path length that is approximately zero.

15. An etalon comprising:
a rutile material having a first thickness d₁, a first index of refraction n₁, and a first coefficient of thermal optical path length change β₁;
a glass material having a second thickness d₂, a second index of refraction n₂, and a second coefficient of thermal optical path length change β₂ , wherein the ratio d₁/d₂ equals-(n₂β₂ )/(n₁β₁).
